(19) United States
(12) Patent Application Publication
(10) Pub. No.: US 2021/0099010 A1
(43) Pub. Date: Apr. 1, 2021

(54) A LIGHTING SYSTEM HAVING LIGHTING UNITS WITH LOCAL ENERGY STORAGE

(71) Applicant: SIGNIFY HOLDING B.V., EINDHOVEN (NL)

(72) Inventor: Priya Ranjan MISHRA, EINDHOVEN (NL)

(21) Appl. No.: 16/603,768

(22) PCT Filed: Apr. 5, 2018
(86) PCT No.: PCT/EP2018/058745

§ 371 Date: Oct. 8, 2019

(30) Foreign Application Priority Data
Apr. 11, 2017 (IN) 201741012941
Jun. 13, 2017 (EP) 17175658.8

(51) Int. Cl. H02J 9/06; H05B 47/10

(52) U.S. Cl. CPC H02J 9/065; H05B 47/10

(57) ABSTRACT

A lighting system comprises a first lighting unit with a first energy storage device and a second unit with a second energy storage device, wherein said first lighting unit and said second unit are spatially separated from each other. Energy of the first energy storage device may be relocated to the second energy storage device in response to reception of a hazard signal such as a fire alarm signal, in particular relating to the location of the first energy storage device. This system reduces fire risks in a building having a networked lighting system, such as used in an office environment.

### FIELD OF THE INVENTION

This invention relates to lighting networks, and in particular having lighting units (luminaires) with local battery backup.

### BACKGROUND OF THE INVENTION

With advent of LED lamps, the power requirement for lighting has reduced significantly. It is now also feasible to integrate batteries into luminaires to allow for example 1 to 2 hours of main power supply outage.

With the decrease in cost and increase in energy density, Li-ion batteries are becoming increasingly popular and common in use. However, Li-ion batteries pose an inherent risk because of the Li material. Despite the fact that in secondary Li-ion batteries, the Li compound is intercalated in the electrode material they still pose safety concerns because the electrolyte material is flammable and the cells are pressurized.

There is consequently a safety hazard risk due to explosion at increased temperatures, which may result in the case of a fire. This applies particularly to Li-ion batteries, but also to other battery types. In particular, batteries all store electrical energy in chemical form and many of these chemicals generally pose a fire risk.

In portable devices such as smart phones, the quantity of stored energy is quite low and such devices are considered safe. This means that it is for example permitted to carry such devices (in which the Li-ion battery is embedded in the product) in air travel, with the battery in these applications typically limited to 100 Wh or 8 g equivalent Li. However, spare batteries, additional battery back-up systems, etc. have restrictions for air transport. This is also the case for shipment of cells and batteries for which specific packing and safety measures are required.

In general, the density of Li-ion batteries that will be used for lighting applications in offices is in the range 150-250 Wh.

It has been proposed in JP 2014/075906 to implement a battery discharge system for luminaires of a lighting system based on the detection of a fire within a building. This discharge system consumes the energy in the battery by a discharge resistor or feeds the energy to the grid. In short, the energy is gone forever. This will give rise to an increase in cost of each luminaire as well as an increase in energy consumption, the overall lighting system has possibly hundreds of lighting fixtures so that the overall material and energy cost increases become significant. False alarms will lead to discharge of batteries and loss of stored energy together with a decrease in the remaining cycle life.

Furthermore, a fire may result in a loss of mains power, so that discharging the batteries of the luminaries will mean that emergency lighting is no longer available, just when it is most needed.

There is therefore a need for a system which renders luminaires safe in the event of a fire, but which avoids the drawbacks outlined above.

### SUMMARY OF THE INVENTION

A basic idea of the embodiment of the invention is relocating the energy in the battery of some lighting units (luminaires) to the battery of another unit, like another lighting unit (luminaire) or a dedicated energy storage facility, without being consumed forever, in case of fire. One architecture enabling this re-locating is disclosed by WO2013/182927. It discloses a network of luminaires, each with individual batteries. When the battery in one luminaire is low, the energy in other luminaires can be routed to the luminaire. In this prior art, the re-located energy is consumed by the luminaire for maintaining an illumination output, without charging the battery in that luminaire.

The invention is defined by the claims.

According to examples in accordance with an aspect of the invention, there is provided a lighting system comprising:

a first lighting unit with a first energy storage device;

a second unit with a second energy storage device, wherein said first lighting unit and said second unit are spatially separated from each other;

an interface adapted to receive a signal indicative of a hazard; and

a controller, wherein the controller is adapted to relocate energy of the first energy storage device to the second energy storage device in response to reception of said signal.

This system reduces fire risks in a building having a networked lighting system, such as used in an office environment. The energy storage device (i.e. battery) of a lighting unit is discharged to a second energy storage device. In this way, the energy is not simply dissipated such as through an emergency load, but is redistributed within the system without significant loss, so that a more efficient use of energy is achieved. The energy relocation may also take account of the charging and discharging characteristics of the different energy storage devices within the system, as well as their current state of charge. Thus, the energy relocation can be carried out in a way which maintains the lifetime of the energy storage devices.

The energy storage device in the first lighting unit is preferably a battery, such as a Li-ion battery. It typically has an energy storage capacity greater than 100 Wh for example in the range 150 Wh to 250 Wh.

The signal indicative of a hazard for example comes from a building management system, having a network of hazard sensors, such as smoke detectors and temperature detectors. Alternatively, the signal indicative of a hazard comes from a local sensor of the first lighting unit which is most close to the hazard. It is noted that the hazard may be an internal hazard of the lighting unit itself due to its malfunction such as overheating, or it may be an external hazard such as a fire in the room.

In practice, there are preferably tens or even hundreds of lighting units in the system.

The controller may be adapted to obtain a hazard location from said signal. By identifying the hazard location, the energy relocation can be controlled in an intelligent way, taking account of the lighting units near the hazard as well as the need for lighting away from the direct proximity of the hazard.

The system may comprise a plurality of lighting units including said first lighting unit, wherein said controller is adapted to identify the first lighting unit as requiring energy relocation based on the hazard location, such as based on being relatively close to the hazard location.

In this way, the system can render the lighting units safe which are close to a fire hazard.

The controller may be adapted to identify the second unit as suitable for receiving relocated energy based on the hazard location, such as based on being relatively remote from the hazard location, or in a hazard-safe place such as a refuge area. In this way, the risk is reduced as much as possible.

The second unit may also be a lighting unit in the plurality of lighting units, which is along a path for evacuation in response to said hazard. Thus, emergency lighting can be maintained. In this way, the system can maintain lighting which is essential for guiding people to exit the building, because the discharge of energy is carried out in dependence on the hazard (e.g. fire) location.

The second unit may instead comprise a dedicated energy storage device, and said second energy storage device may comprise an electrochemical storage device, an electromechanical storage device, or an electrical storage device.

The system may have only lighting units, which redistribute energy between them. However, in accordance with this feature, a dedicated (non-lighting) energy storage unit is provided. It may be located away from all fire risks, for example in an out-building or fire and heat proof enclosure.

The controller may be adapted to decrease an energy in the first energy storage device below a safe threshold level in response to the signal indicative of a hazard. The stored chemical energy may be reduced below a risk level, but in a way which prevents loss of cycle lifetime.

The controller may be adapted to relocate the relocated energy in the second energy storage device back to the first energy storage device when the hazard ceases. In this way, the energy is not dissipated, but is still available for use for the first lighting unit.

The lighting system may further comprise:

a DC line interconnecting the first lighting unit and the second unit, and wherein the controller is adapted to couple the first energy storage device with the second energy storage device via the DC line; or

an AC line interconnecting the first lighting unit, the second unit and an AC mains input, wherein the first lighting unit further comprises an inverter, and said controller is adapted to isolate the lighting system from the AC main input and to couple the first energy storage device with the second energy storage device via the inverter of the first lighting unit and the AC line.

There are thus various ways to implement the energy redistribution system, either DC or reusing the AC wiring.

The first energy storage device may comprise a plurality of batteries each of which has a capacity lower than 100 Wh, and the plurality of batteries are displaced from each other within the first lighting unit.

This reduces the fire risk within a unit. For example, the batteries may be connected in series to reach a desired overall capacity, and in response to the hazard signal, they may be disconnected electrically from each other.

Examples in accordance with another aspect of the invention provide a method of controlling a lighting system which comprises a first lighting unit with a first energy storage device and a second unit with a second energy storage device, wherein said first lighting unit and said second unit are spatially separated from each other, wherein the method comprises:

detecting a hazard; and

relocating energy of the first energy storage device to the second energy storage device in response to detection of said hazard.

This method shifts energy around a network of devices to relocate energy away from a fire hazard.

The method may further comprise determining a hazard location, and identifying the first lighting unit as requiring energy relocation based on proximity to the hazard location, and identifying the second unit as suitable for receiving relocated energy based on remoteness from the hazard location.

Emergency lighting may be provided along a path for evacuation in response to said hazard. An energy in the first energy storage device may be decreased below a safe threshold level.

The invention may be implemented at least in part in software. For example, the method may be implemented jointly by a lighting system controller and a building management system.

These and other aspects of the invention will be apparent from and elucidated with reference to the embodiment(s) described hereinafter.

### BRIEF DESCRIPTION OF THE DRAWINGS

Examples of the invention will now be described in detail with reference to the accompanying drawings, in which:

FIG. 1 shows a lighting system;

FIG. 2 shows a method of controlling a lighting system; and

FIG. 3 shows an alternative design of lighting unit for use in the system of FIG. 1.

### DETAILED DESCRIPTION OF THE EMBODIMENTS

The invention provides a lighting system which comprises a first lighting unit with a first energy storage device and a second unit with a second energy storage device, wherein said first lighting unit and said second unit are spatially separated from each other.

Energy of the first energy storage device may be relocated to the second energy storage device in response to reception of a hazard signal such as a fire alarm signal, in particular relating to the location of the first energy storage device.

This system reduces fire risks to the energy storage device in a building having a networked lighting system, such as used in an office environment.

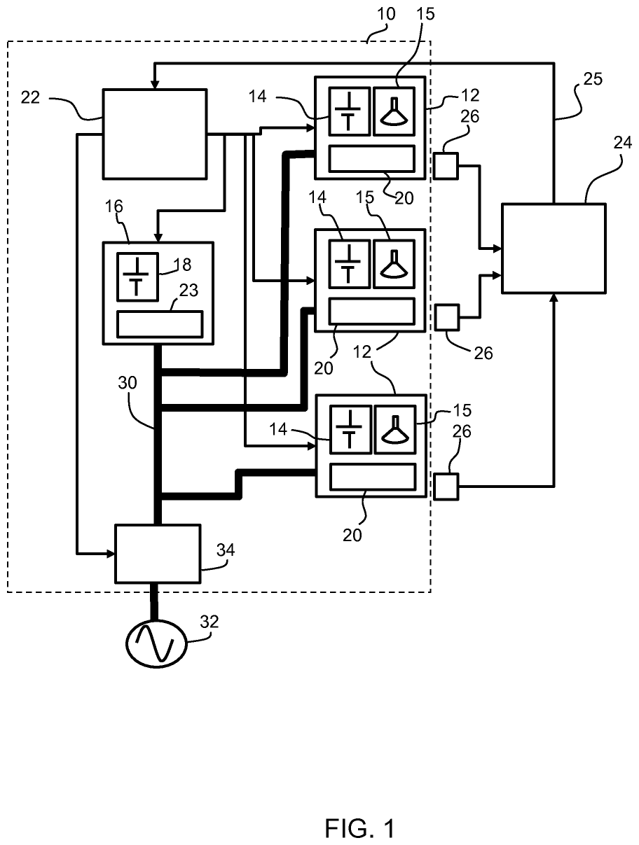

FIG. 1 shows a lighting system 10 comprising a network of lighting units 12. There is at least a first lighting unit with a first energy storage device 14 such as a Li-ion battery and a light output device 15. FIG. 1 also shows an energy storage unit 16 having another energy storage device 18, and this unit does not have a lighting unit. The energy storage unit may comprise another battery of the same or different general type as used in the lighting units, or it may comprise a storage device which is not a battery, but is a different type of electrochemical storage device, or indeed an electromechanical storage device, or an electrical storage device.

There is thus at least one second unit with a second energy storage device. The second unit may be another lighting unit 12, or it may be an energy storage unit 16. The system 10 is designed to enable energy transfer between the energy storage devices 14, or between the energy storage device 14 and the energy storage device 18 of the system in an adaptive manner as will be explained below.

The lighting units and the energy storage units are spatially separated from each other, for example they are in different rooms within a building, or different parts of different rooms. A non-lighting energy storage unit 16 may also be outside the building or in a relatively safe area within the building.

Each lighting unit 12 has a lighting unit controller 20, and there is a lighting system controller 22. The energy storage unit or units 16 also have a local controller 23 for controlling the energy transfer process, and the charging and discharging cycles. The lighting unit controllers 20 control the operation of the light output devices 15 and also implement control of the energy transfer functionality as well as the charging and discharging cycles. Each lighting unit 12 and energy storage unit 16 receives control signals from the lighting system controller 22.

The lighting system 10 receives an input 25 which may be generated by sensors which form part of the lighting system or which may be generated by an external system, indicative of a hazard such as a fire. In the example of FIG. 1, this signal 25 comes from a building management system (BMS) 24 which receives input from sensors 26. The BMS is able to identify the presence and location of a fire hazard based on elevated temperatures and/or smoke detection. The hazard signal 25 is provided to the lighting system controller 22. There may additionally or alternatively be temperature sensing at each lighting unit to provide overheat information. Thus, the hazard may relate to either internal overheating due to a malfunction of the lighting unit, or it may relate to external overheating due to an outside fire hazard.

The lighting system controller 22 is adapted to relocate energy of the at least one energy storage device to at least one other energy storage device within the system, in response to reception of the hazard signal 25.

In a simplest implementation, energy is routed from a lighting unit to a remote/safe energy storage unit, where it is stored while the hazard remains active. However, in a preferred system, energy can be redistributed around the full network of units, which may comprise multiple lighting units and one or more remote energy storage units.

This system reduces fire risks in a building having a networked lighting system by discharging the energy storage devices of lighting units to other energy storage devices. In this way, the energy is not simply dissipated such as through an emergency load, but is redistributed within the system so that a more efficient use of energy is achieved. The energy relocation may also take account of the charging and discharging characteristics of the different energy storage devices within the system, as well as their current state of charge. Thus, the energy relocation can be carried out in a way which maintains the lifetime of the energy storage devices.

This redistribution is of particular interest when the capacity of Li-ion batteries exceeds levels where a fire hazard is created, such as in the range 150 Wh to 250 Wh.

The BMS 24 may simply indicate the existence of a hazard so that in a simplest system, all lighting units are discharged to a remote energy storage facility. However, by including the hazard location, the energy relocation can be controlled in an intelligent way, taking account of the lighting units near the hazard as well as the need for lighting away from the direct proximity of the hazard. Thus, lighting units near the hazard may discharge energy and lighting units far from the hazard may receive energy.

Lighting can then still be provided in lighting units remote from the hazard even if there is a mains power outage, for example emergency exit lighting may be provided.

Complete battery discharge may not be required. For example, the lighting system controller may be adapted to decrease an energy in the lighting unit energy storage device near the hazard just below a safe threshold level. The stored chemical energy is then maintained below a risk level, but in a way which prevents loss of cycle lifetime. The energy may further be sufficient for an emergency use like ten minutes' use, but a substantial part of the energy is relocated.

When the hazard has ended, the controller 22 may instruct the energy storage units that receive the energy to return it to the lighting units to enable continued backup lighting. Thus, the redistributed energy is not dissipated, but is still available for use.

To enable the transfer of energy between the units, there is a connection line 30. This line interconnects all of the lighting units and the energy storage units.

In a first example, the connection line 30 may function as the power supply line to each unit from an external mains supply 32. During energy redistribution, the line 30 is isolated from the mains 32, and an isolation switch 34 is provided for this purpose.

In case the external mains supply 32 is AC, the line 30 in this case is an AC line. Each unit then comprises an inverter as part of the local controller 20,23. The central lighting system controller 22 is adapted to isolate the lighting system from the AC mains input using the isolation switch 34 and then to control the coupling of energy storage devices via the inverters.

In a second example, the connection line 30 receives a DC rectified supply voltage signal instead of the AC mains 32 so that the line 30 is a DC line. The central lighting system controller again couples the energy storage devices via the DC line.

In a hybrid system, there are AC line connecting the lighting units and the AC mains, and a DC line coupling the lighting units and the energy storage device 16. The central lighting system controller may use the DC line for the energy relocation to avoid power loss in the inverters.

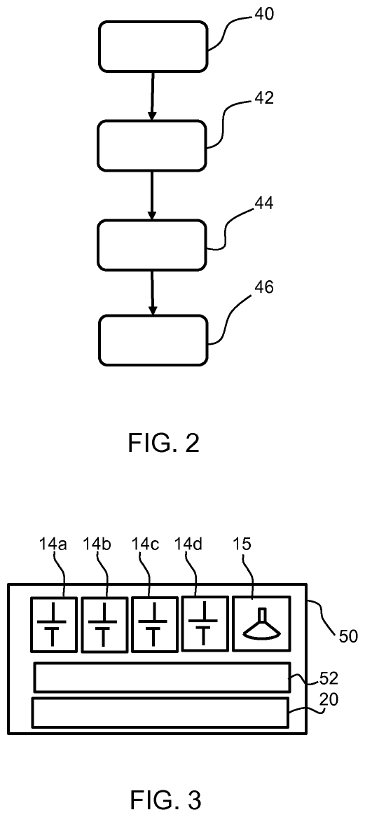

FIG. 2 shows a method of controlling the lighting system.

In step 40 a hazard is detected, for example in the form of a fire alarm generated by a BMS, which is then relayed to the lighting system controller, preferably with location identification.

In step 42, the central lighting system controller isolates lighting units from the network which are closest to the hazard. The central lighting system controller for example maps the lighting units which have excess energy and those which have lower energy than a threshold level.

In step 44, emergency lighting is generated by the suitable lighting units, which have not been isolated.

In step 46, energy is relocated from one energy storage device (or a group of energy storage devices) to another energy storage device (or another group of energy storage devices) in response to detection of the hazard.

For a DC line, this is achieved by opening a battery port to the line 30, which functions as a common DC grid. For an AC line, the local inverter is used to couple to the AC line.

Each lighting unit is then instructed by the lighting system controller to feed energy or sink energy according to the prevailing level of charge in each unit and the location relative to the hazard. There may be a threshold distance beyond which any charge level is permitted and below which the charge must be maintained below a charge threshold. This provides a binary definition of allowed charge, but there may be multiple levels of permitted charge in dependence on distance.

Lighting unit energy from one lighting unit can be shared with one or more other lighting units based on an energy redistribution plan generated by lighting system controller. The energy redistribution plan is for example based on a people evacuation plan and also on the energy needed to maintain lighting on a predefined exit route. Predefined routes may vary and will depend on the evacuation plan which itself is based on the location where the hazard alarm is generated.

The discharge operation may be performed sequentially, for example in order of proximity to the hazard, starting with the nearest point to the fire hazard.

This method shifts energy around a network of devices to relocate energy away from a fire hazard.

Note that the central lighting system controller and the BMS may in fact be part of a single integrated system controller.

The system may also include lighting units without energy storage devices, and the DC grid may enable surplus energy to be used to light them even though they have no local energy storage.

The system above provides energy transfer between distant units to reduce local fire hazards. An additional measure is to split the local battery capacity into two or more compartments so that the energy stored in each individual compartment is maintained below a threshold such as 100 Wh.

FIG. 3 shows a lighting unit 50 with four separate battery compartments 14a, 14b, 14c, 14d. More generally, the first energy storage device comprises a plurality of batteries (each of which preferably has a capacity lower than 100 Wh) and the plurality of batteries are displaced from each other within the first lighting unit.

The battery compartments are connected by a switch arrangement 52 so that they may be connected in series or isolated from each other. The number of switches in the switch arrangement will depend on the number of compartments. In the case of a fire alarm, the switches open so that the battery compartments are isolated. To add evacuation, one set of battery cells (one compartment) may be connected directly to a minimum number of LEDs of the light output device 15 required for illumination to aid evacuation. A current limiting circuit may also be used.

The batteries in the other compartments may be discharged to implement charge redistribution as explained above.

The risk of explosion is in this way further reduced by providing the batteries in each compartment with a capacity below 100 Wh.

A system for distributing power between lighting units, in order to provide emergency lighting, is described in WO 2013/182927 as mentioned above. The architecture for transferring charge between lighting units described in that application may be employed to provide the safety functionality described above.

In particular, in a conventional mode in the presence of AC power and with no hazard signal, the lighting units operate as conventional individual lamps, in a battery charge or trickle charge mode. The presence of AC power (i.e., grid main power) is for example monitored by a power monitoring unit (e.g. in the controller 22). In absence of the AC power, the power monitoring unit sends a signal to the isolator switch 34 to disconnect local distribution from the AC mains 32.

In the presence of a hazard signal, individual lighting units may be isolated in the manner explained above.

The lighting units may then switch to form a DC network for DATA and power transfer. When the AC power is restored and there is no longer a hazard signal, the power monitoring unit sends another signal to all the lighting units to switch to the AC power.

The lighting system controller monitors the state of charge of the batteries of the lighting units. Communication between the lighting system controller and the lighting units may be PLC (power line communication) or any other conventional means including dedicated control lines (as shown in FIG. 1) or wirelessly.

Each lighting unit has a unique identifiable code that can be addressed. Once protocol hand shaking between two or more lighting units is complete a lighting unit which has stored energy to be redistributed will allow the access to its battery to the other lighting units or the energy storage unit.

When two units (lighting units or energy storage units) are transferring energy, the other units in the network will for example be either isolated or in a high impedance mode. Thus, it is possible to control the energy redistribution as between coupled pairs of units. However, more complicated schemes are possible with simultaneous transfer from one or more units to one or more other units, with local control of the discharge characteristics and the charge characteristics.

The invention may be implemented at least in part in software. For example, the method may be implemented jointly by a lighting system controller and a building management system.

As discussed above, embodiments make use of one or more controllers. The or each controller can be implemented in numerous ways, with software and/or hardware, to perform the various functions required. A processor is one example of a controller which employs one or more microprocessors that may be programmed using software (e.g., microcode) to perform the required functions. A controller may however be implemented with or without employing a processor, and also may be implemented as a combination of dedicated hardware to perform some functions and a processor (e.g., one or more programmed microprocessors and associated circuitry) to perform other functions.

Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media such as volatile and non-volatile computer memory such as RAM, PROM, EPROM, and EEPROM. The storage media may be encoded with one or more programs that, when executed on one or more processors and/or controllers, perform the required functions. Various storage media may be fixed within a processor or controller or may be transportable, such that the one or more programs stored thereon can be loaded into a processor or controller.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A lighting system comprising:
a first lighting unit with a first energy storage device;
a second unit with a second energy storage device wherein said first lighting unit and said second unit are spatially separated from each other;
an interface adapted to receive a signal indicative of a hazard; and
a controller, wherein the controller is adapted to relocate energy of the first energy storage device to the second energy storage device in response to reception of said signal.

2. The system as claimed in claim 1, wherein the controller is adapted to obtain a hazard location from said signal.

3. The lighting system as claimed in claim 2, comprising a plurality of lighting units including said first lighting unit, wherein said controller is adapted to identify the first lighting unit as requiring energy relocation based on the hazard location, such as based on being relatively close to the hazard location.

4. The lighting system as claimed in claim 3, wherein the controller is adapted to identify the second unit as suitable for receiving relocated energy based on the hazard location, such as based on being relatively remote or safe from the hazard location.

5. The lighting system as claimed in claim 3, wherein the second unit is also a lighting unit in the plurality of lighting units, which is along a path for evacuation in response to said hazard.

6. The lighting system as claimed in claim 3, wherein the second unit comprises a dedicated energy storage device, and said second energy storage device comprises an electrochemical storage device, an electromechanical storage device, or an electrical storage device.

7. The lighting system as claimed in claim 1, wherein the controller is adapted to decrease an energy in the first energy storage device below a safe threshold level in response to the signal indicative of a hazard.

8. The lighting system as claimed in claim 1, wherein the controller is adapted to relocate the relocated energy in the second energy storage device back to the first energy storage device when the hazard ceases.

9. The lighting system as claimed in claim 1, comprising:
a DC line interconnecting the first lighting unit and the second unit, and wherein the controller is adapted to couple the first energy storage device with the second energy storage device via the DC line; or
an AC line interconnecting the first lighting unit, the second unit and an AC mains input, wherein the first lighting unit further comprises an inverter, and said controller is adapted to isolate the lighting system from the AC main input and to couple the first energy storage device with the second energy storage device via the inverter of the first lighting unit and the AC line.

10. The lighting system as claimed in claim 1, wherein the first energy storage device comprises a plurality of batteries each of which has a capacity lower than 100 Wh, and the plurality of batteries are displaced from each other within the first lighting unit.

11. A method of controlling a lighting system which comprises a first lighting unit with a first energy storage device and a second unit with a second energy storage device, wherein said first lighting unit and said second unit are spatially separated from each other, wherein the method comprises:
detecting a hazard; and
relocating energy of the first energy storage device to the second energy storage device in response to detection of said hazard.

12. The method as claimed in claim 11, further comprising determining a hazard location, and identifying the first lighting unit as requiring energy relocation based on proximity to the hazard location, and identifying the second unit as suitable for receiving relocated energy based on remoteness from the hazard location.

13. The method as claimed in claim 11, comprising providing emergency lighting along a path for evacuation in response to said hazard.

14. The method claimed in claim 11 comprising decreasing an energy in the first energy storage device below a safe threshold level.

15. The computer program product comprising computer program code means adapted to implement the method of claim 11 when said program is run on a computer.
